(19) United States
(12) Patent Application Publication
(10) Pub. No.: US 2017/0256008 A1
(43) Pub. Date: Sep. 7, 2017

(54) STORAGE EQUIPMENT AND APPURTENANCES LOAN-OUT SYSTEM

(71) Applicant: FULLTIME SYSTEM CO., LTD., Tokyo (JP)

(72) Inventor: SHUHEI HARA, Tokyo (JP)

(73) Assignee: FULLTIME SYSTEM CO., LTD., Tokyo (JP)

(21) Appl. No.: 15/059,359

(22) Filed: Mar. 3, 2016

(51) Int. Cl. G06Q 50/16; G07C 9/00

(52) U.S. Cl. CPC G06Q 50/163; G07C 9/00912; G07C 9/00571

(57) ABSTRACT

The invention is a method and a related storage equipment and appurtenances loan-out system to loan out a variety of appurtenances corresponding to the diversification of needs of the resident in a housing complex. A storage equipment aspect stores appurtenances to be loaned out to a resident, a control server controls and updates the data relative to loan-out of the appurtenances and provides a report function; a user terminal is operated by the resident and a controller terminal is operated by a managerial personnel entity who manages and runs the appurtenance loan-out service following the method and steps provided.

### CROSS REFERENCE TO RELATED APPLICATIONS

This application relates to, but does not claim priority from, JP 2014-191688 filed Sep. 19, 2014, the entire contents of which are incorporated by reference.

### FIGURE SELECTED FOR PUBLICATION

FIG. 1

### BACKGROUND OF THE INVENTION

Field of the Invention

The present invention relates to a storage equipment and appurtenances loan-out system, method for using the same, and particularly relates to a storage equipment and an appurtenances loan-out system in order to loan out an appurtenance and a tool to a resident in a housing complex.

Description of the Related Art

Recently, in the housing complex such as an apartment, it is common that a variety of services, which include providing a use of common area, e.g., a conference room and a theater room, or loan-out of an electric bicycle to the resident, are available for residents. The common areas or the key for the electric bicycle must be loaned out so that the variety of services can be applied. Traditionally, in such housing complex, a superintendent standing by in the superintendent room controls such appurtenances and loan out the appurtenances to the resident who wants to use.

Patent Document 1, noted below, and incorporated herein by reference, discloses a key control equipment of the sharing system relative to an electric assist bicycle, by which loan-out of appurtenances available in the service provided in such housing complex is automatically managed so that the work load of, e.g., the superintendent can be reduced in practice. Referring to Patent Document 1, the key control equipment is installed in, e.g., the superintendent room and a certain key to be loaned out is visually identified from outside and held in the locked status on the front panel. The resident will have an authentication through the own ID card and when the authentication is successfully completed, the lock is unlocked and the key becomes available for loan-out.

### PATENT DOCUMENT

Patent Document 1: JP Patent Published 2001-27060

### ASPECTS AND SUMMARY OF THE INVENTION

However, since the key control equipment referring to Patent Document 1 is installed in the superintendent room, the key may not be available when the superintendent is out of the room. Specifically, generally speaking, the superintendent is not available 24 hours a day and goes back to home after work and no one will be in the room. Accordingly, the resident cannot get the key for loan-out service described above during the length of time when no one is in the superintendent room despite increasing needs as for a night use of the service along with the recent diversification of life style.

Further, even when the superintendent is on duty, if loan-out of appurtenances takes place often, the superintendent would be busy to loan out the appurtenance and might not well perform normal managerial works for the housing complex.

Further, as the key control equipment referring to Patent Document 1 described above is structurally specified only to hold keys using the key holding mechanism, it is difficult to apply for loan-out of other appurtenances and it is problematic that the diversification of needs of the resident, which is recently remarkable, cannot be well corresponded.

One purpose of the present invention is to solve the above problems and to provide a storage equipment and an appurtenance loan-out system to loan out a variety of appurtenances corresponding to the diversification of needs of the resident in a housing complex.

According to another aspect of the present invention, there is provided a method and a related storage equipment and appurtenances loan-out system to loan out a variety of appurtenances corresponding to the diversification of needs of the resident in a housing complex. A storage equipment aspect stores appurtenances to be loaned out to a resident, a control server controls and updates the data relative to loan-out of the appurtenances and provides a report function; a user terminal is operated by the resident and a controller terminal is operated by a managerial personnel entity who manages and runs the appurtenance loan-out service following the method and steps provided.

### Means for Solving the Problem.

A storage equipment of the present invention to solve such problems is the storage equipment installed in a housing complex and comprises more than one lockable storage box to store appurtenances, wherein the storage box storing the appurtenances what the resident wants is unlocked when the authentication based on the resident ID that distinguish the resident is successfully completed.

Further, according to the storage equipment of the present invention, the storage equipment comprises a key for a common area in the housing complex, a vehicle key, a wheeled platform, a tool, leisure/picnic goods and gardening supplies.

Further, the storage equipment of the present invention controls the database, in which the purpose of each storage box is set up, and targets only storage box, of which the purpose is to store appurtenances, to be unlocked referring to the database when the authentication processing is executed relative to appurtenance loan-out.

Further, the appurtenance loan-out system comprises the storage equipment and a control server that controls the storage equipment and an appurtenance loan-out linked thereto via a network, and a user terminal connected thereto via the control server and the network, and wherein the storage equipment sends the input data to the control server, when a resident inputs the data specifying an preferable appurtenance item; and the control server refers to the server and identifies the storage box storing the certain appurtenance item when the data, specifying the appurtenance item, is received from the storage equipment, and sends the unlocking signal of the identified storage box to the storage equipment so that the storage box can be unlocked.

Further, according to the appurtenance loan-out system of the present invention, the control server controls the allowable loan-out length specifying the longest allowable loan-out length of the appurtenance every appurtenance relative to each resident, and sends the data so as to remind the return of the appurtenance to the user terminal of the resident making the loan-out when the allowable loan-out length is over from the time of loan-out of the appurtenance.

Further, according to the appurtenance loan-out system of the present invention, the storage equipment sends the input data to the control server when the data specifying the appurtenance item of the loan-out booking and the data relative to the time of the loan-out booking are input; the control server refers to the database when the data specifying the appurtenance item of the loan-out booking and the data relative to the time of the loan-out booking are received; registers the loan-out booking of the appurtenance based on the received data when no other booking is registered; and, sends the unlocking signal of the storage box of the appurtenance to the storage equipment so that the storage box can be unlocked when the request for loan-out of the appurtenance based on the registered booking is received from the storage equipment.

Further, according to the appurtenance loan-out system of the present invention, wherein the storage equipment sends the input data to the control server when the data specifying a appurtenance item to be booked and the booking and loan-out timing thereof are input; and the control server refers to the database when the data specifying the appurtenance item of the loan-out booking and the data relative to the time of the loan-out booking are received; registers the loan-out booking of the appurtenance based on the received data when no other booking is registered; and sends the unlocking signal of the storage box of the appurtenance to the storage equipment so that the storage box can be unlocked when the request for loan-out of the appurtenance based on the registered booking is received from the storage equipment.

Further, according to the appurtenance loan-out system of the present invention, the control sever sends the data to the user terminal of the resident, who has booked, to remind the loan-out of the appurtenance when the booked and registered appurtenance is still not yet loaned out even by the booked time.

Further, according to the appurtenance loan-out system of the present invention, the storage equipment comprises the same database structure as the database structure that the control server has and the data in the database thereof can be shared with the control server.

Further, according to the appurtenance loan-out system of the present invention, the appurtenance loan-out system comprises the storage equipment and a user terminal, which is operated by the resident, connected thereto via the storage equipment and the network, and wherein the storage equipment refers to the database when a resident inputs the data specifying an preferable appurtenance item; and specifies the storage box storing the appurtenance item, and unlocks the identified storage box.

Further, according to the appurtenance loan-out system of the present invention, the storage equipment controls the allowable loan-out length specifying the longest allowable loan-out length of the appurtenance every appurtenance relative to each resident, and sends the data so as to remind the return of the appurtenance to the user terminal of the resident making the loan-out when the allowable loan-out length is over from the time of loan-out of the appurtenance.

Further, according to the appurtenance loan-out system of the present invention, the storage equipment refers to the database when the data specifying the appurtenance item of the loan-out booking and the data relative to the time of the loan-out booking are input; registers the loan-out booking of the appurtenance based on the received data when no other booking is registered; and, unlocks the storage box of the appurtenance when the request for loan-out of the appurtenance based on the registered booking is input.

Further, according to the appurtenance loan-out system of the present invention, the user terminal sends the input data to the control server when the data specifying the appurtenance item of the loan-out booking and the data relative to the time of the loan-out booking are input; the storage equipment refers to the database when the data specifying the appurtenance item of the loan-out booking and the data relative to the time of the loan-out booking are received; registers the loan-out booking of the appurtenance based on the received data when no other booking is registered; and, unlocks the storage box of the appurtenance when the request for loan-out of the appurtenance based on the registered booking is input.

Further, according to the appurtenance loan-out system of the present invention, the storage equipment sends the data to the user terminal of the resident, who has booked, to remind the loan-out of the appurtenance when the booked and registered appurtenance is still not yet loaned out even by the booked time.

In addition, any combination of the structural elements described above, and any replacements each other between the structural element and the expression method, the equipment, the system, the computer program and the medium storing the computer program of the present invention are effective as one aspect of the present invention.

### Efect of the Invention

According to the present invention, the storage equipment comprises appurtenances applied in a housing complex in lockable storage boxes more than one, when the authentication is successfully completed, the locked storage box is unlocked to provide the resident with the preferable appurtenance so that workloads as to management can be reduced and a variety of appurtenances can be loaned out corresponding to the diversification of needs of the resident in the housing complex.

According to another aspect of the present invention, there is provided a method of providing and a method of operating an appurtenance loan-out system containing the features, aspects and elements discussed herein.

The above and other aspects, features and advantages of the present invention will become apparent from the following description read in conjunction with the accompanying drawings, in which like reference numerals designate the same elements.

### BRIEF DESCRIPTION OF THE DRAWINGS

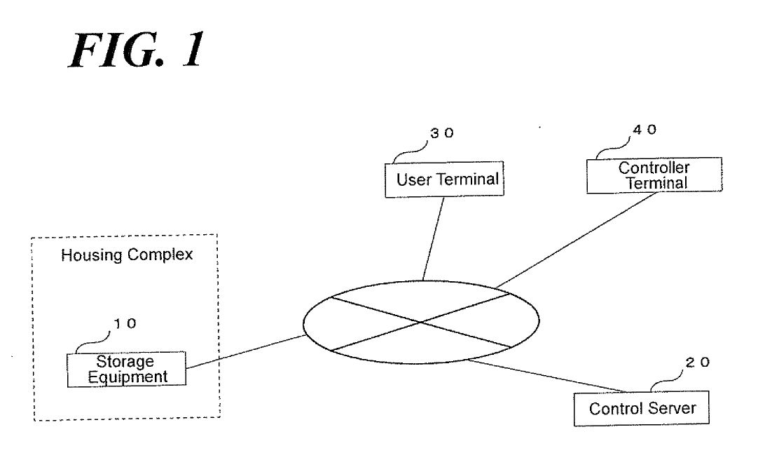

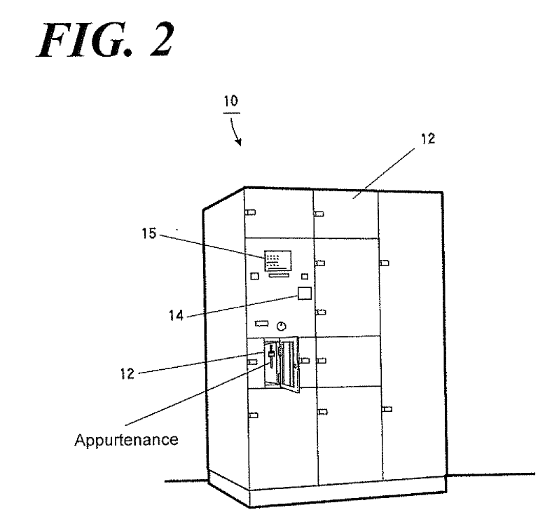

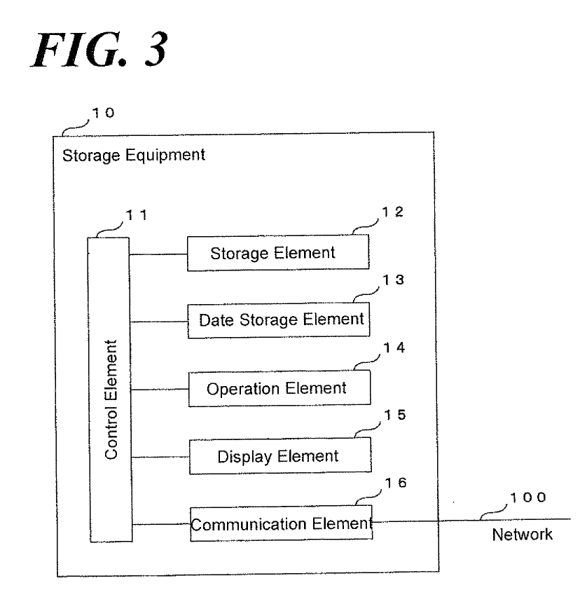

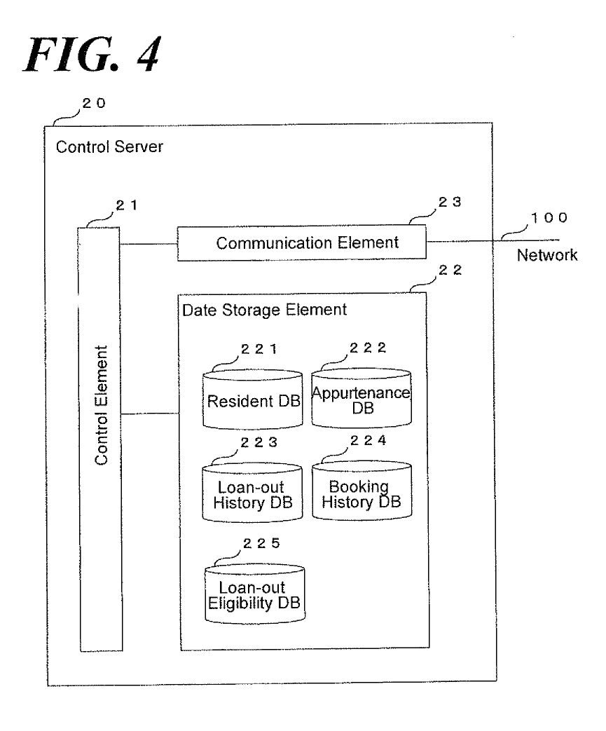

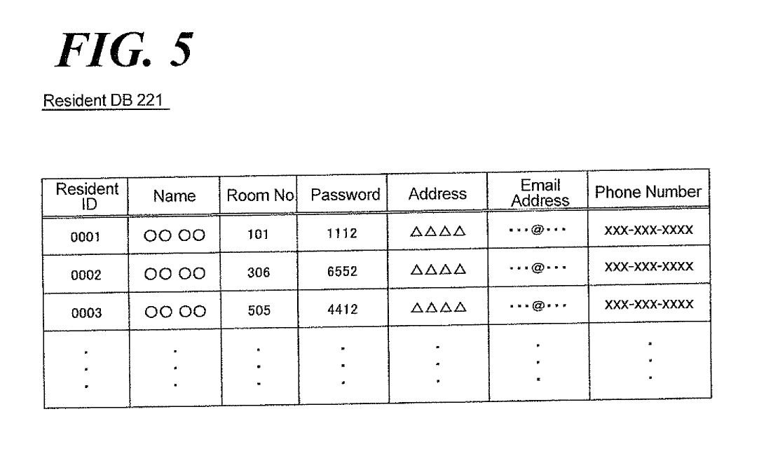

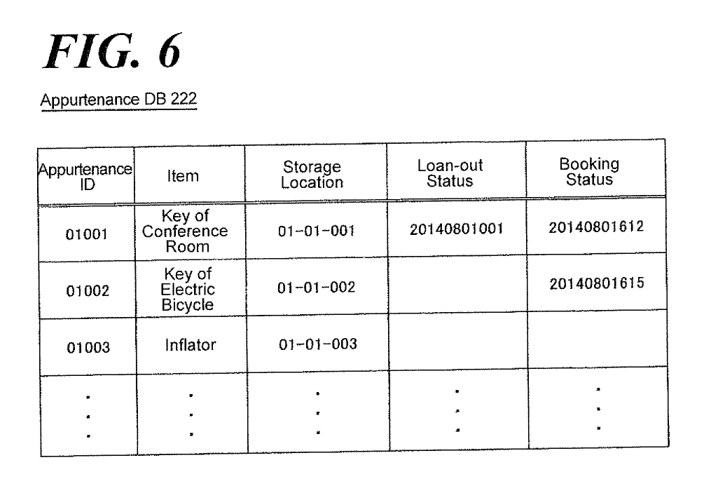

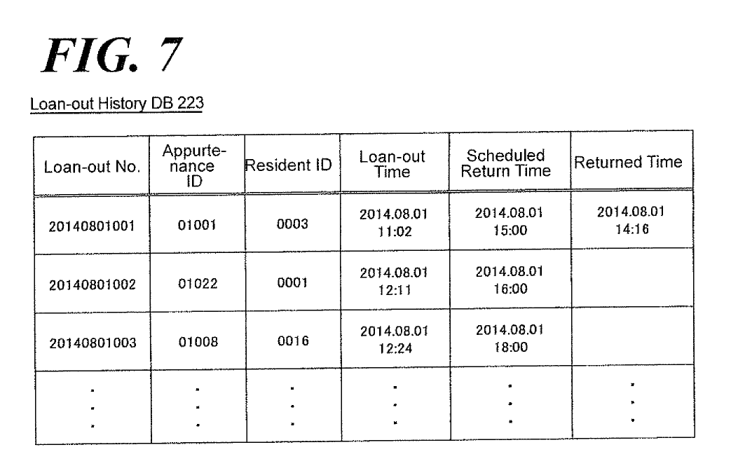

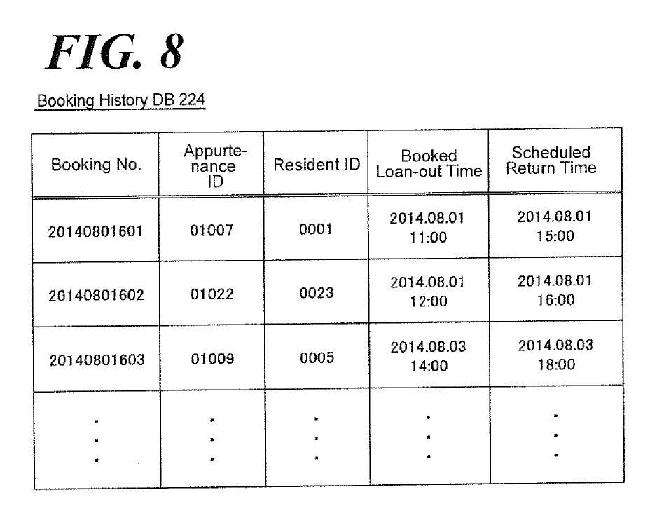

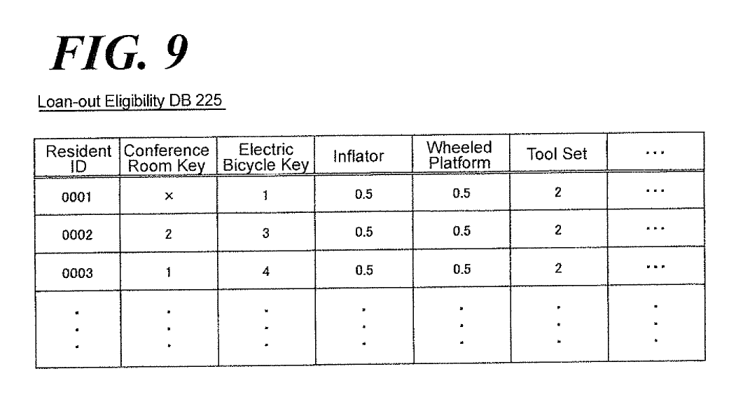

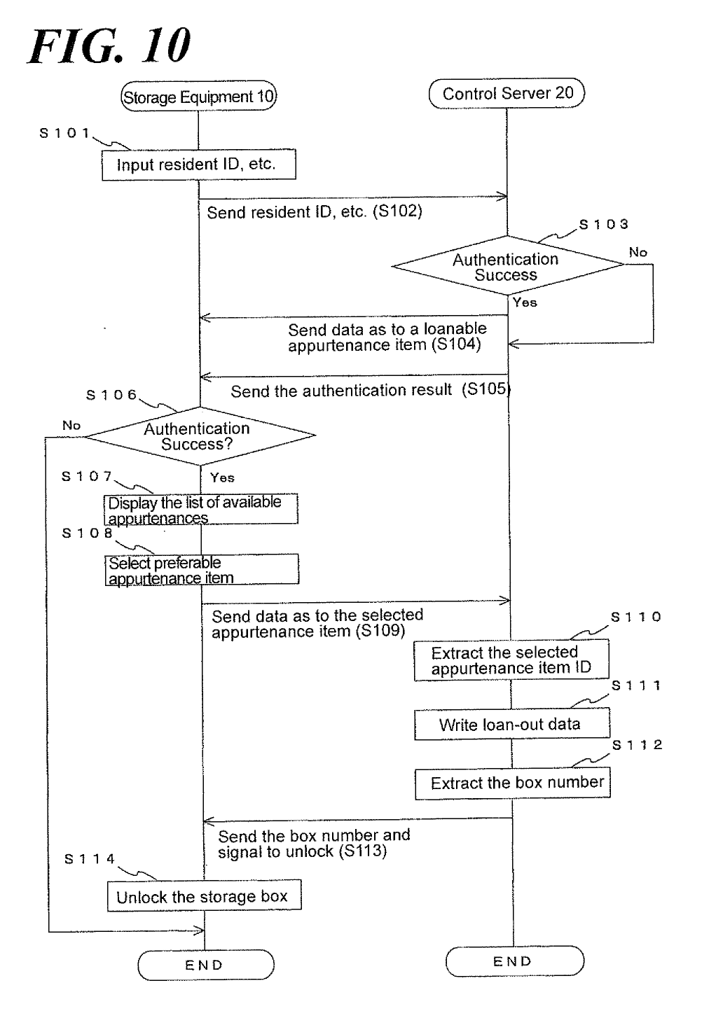

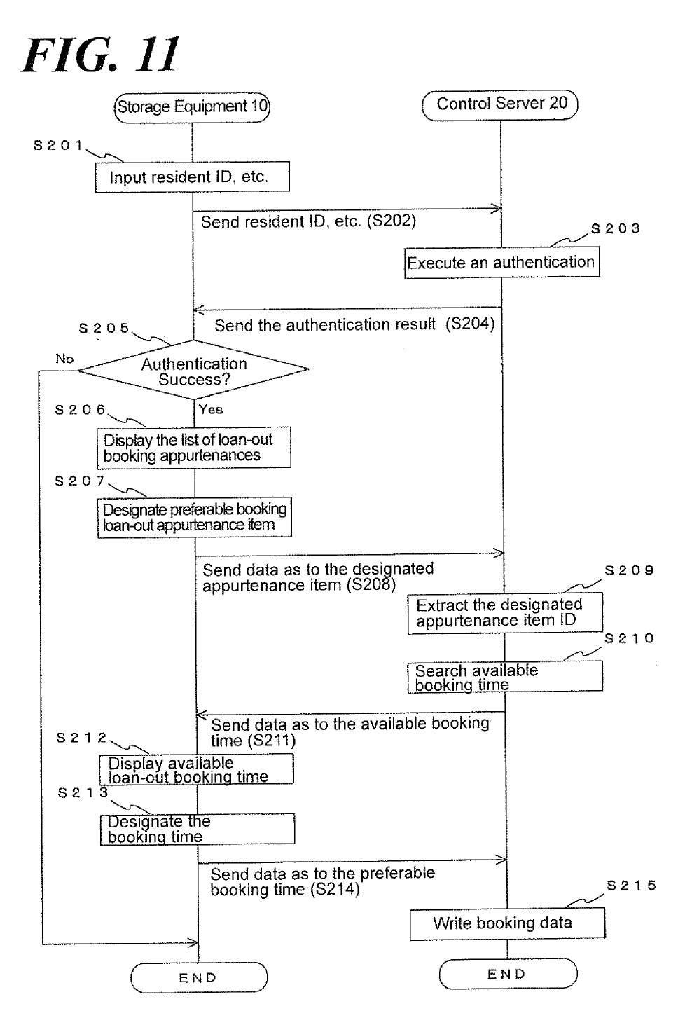

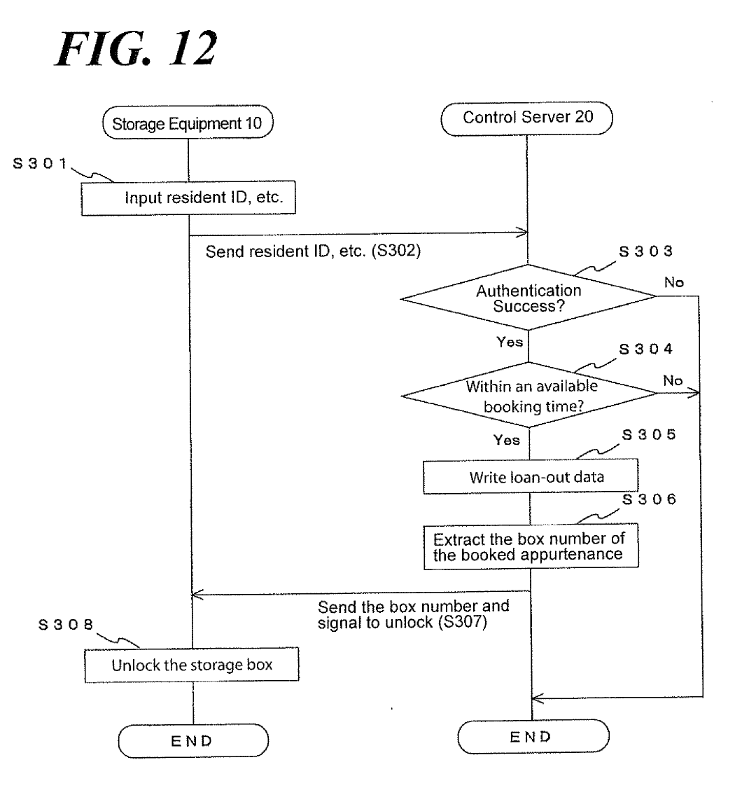

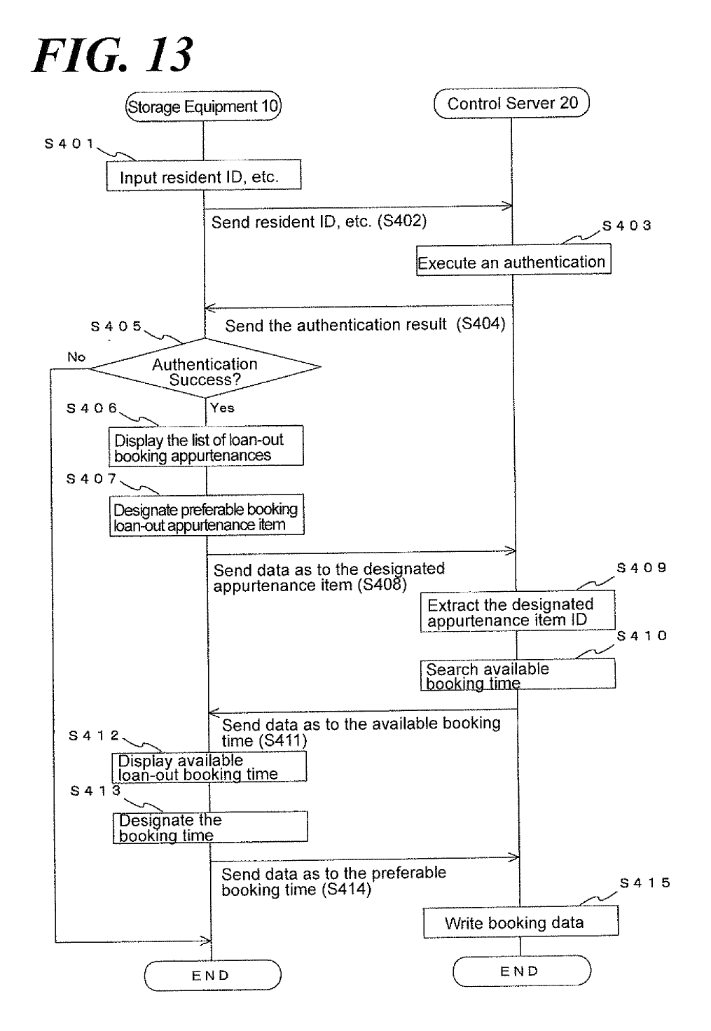

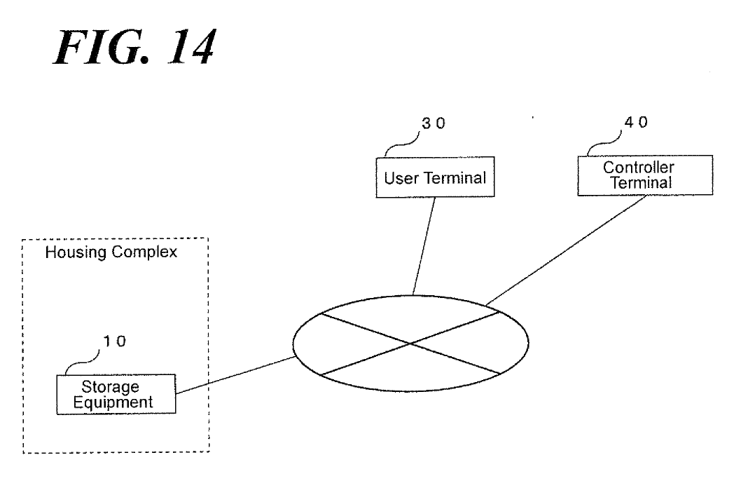

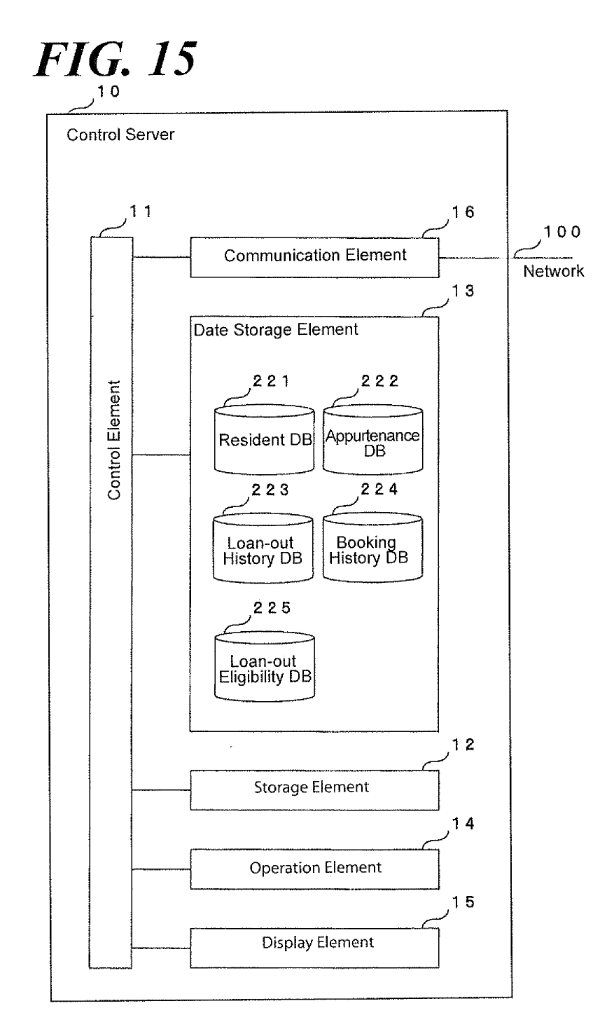

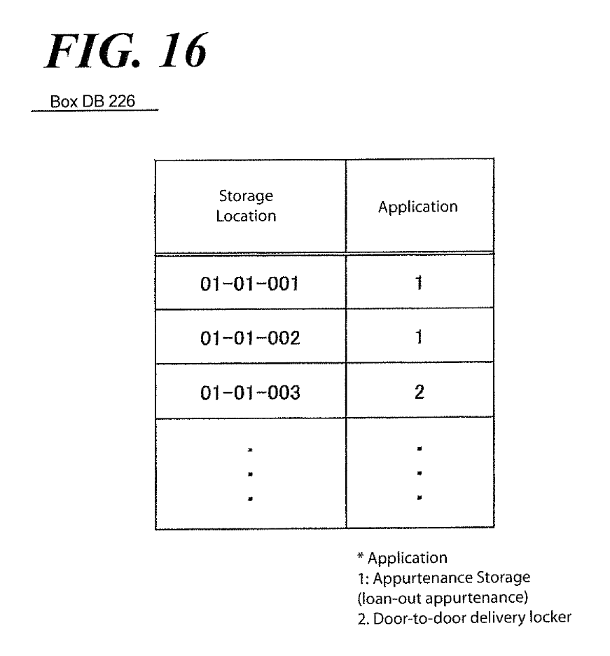

FIG. 1 is a schematic diagram illustrating the structure of an appurtenance loan-out system of the Embodiment 1 of the present invention.

FIG. 2 is a perspective view of a storage equipment of the Embodiment 1 of the present invention.

FIG. 3 is a schematic diagram illustrating the structure of the storage equipment of the Embodiment 1 of the present invention.

FIG. 4 is a schematic diagram illustrating the structure of a control server of the Embodiment 1 of the present invention.

FIG. 5 is a table illustrating the structure of a resident DB (DB is data base) of the Embodiment 1 of the present invention.

FIG. 6 is a table illustrating the structure of an appurtenance DB of the Embodiment 1 of the present invention.

FIG. 7 is a table illustrating the structure of a loan-out history DB of the Embodiment 1 of the present invention.

FIG. 8 is a table illustrating the structure of a booking history DB of the Embodiment 1 of the present invention.

FIG. 9 is a table illustrating the structure of a loan-out eligibility DB of the Embodiment 1 of the present invention.

FIG. 10 is a decision tree illustrating the procedural loan-out sequence relative to an appurtenance loan-out system of the Embodiment 1 of the present invention.

FIG. 11 is a decision tree illustrating the procedural loan-out booking sequence relative to an appurtenance loan-out system of the Embodiment 1 of the present invention.

FIG. 12 is a decision tree illustrating the procedural loan-out sequence of the booked appurtenance to be loaned out relative to an appurtenance loan-out system of the Embodiment 1 of the present invention.

FIG. 13 is a decision tree illustrating the procedural loan-out booking sequence of the appurtenance using a user terminal relative to an appurtenance loan-out system of the Embodiment 1 of the present invention.

FIG. 14 is a schematic diagram illustrating the structure of an appurtenance loan-out system of the Embodiment 2 of the present invention.

FIG. 15 is a schematic diagram illustrating the structure of the storage equipment of the Embodiment 2 of the present invention.

FIG. 16 is a table illustrating the structure of the data of a box DB of the Embodiment 5 of the present invention.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

As an example, it will be understood that the phrase DB or Data Base will further include and require a processing controller for accessing data reading and writing to the Data Base, input devices such as keypads, display elements such as an LCD display or other computer controlled display, a control element capable of interoperably controlling each element, and the network interconnectivity discussed herein so as to allow the proposed system and method to function a speeds necessary for commerce as well as to transmit and update and transform electronic records for each of the same. The interoperability of the processing controller and communication elements and control elements herein allow electronic data changing and transforming of records in each database and for reconciling data records. The process controllers, electronic components, and related elements are each capable of operating and taking steps as required in the present disclosure.

### Embodiment 1

### Structure of the Embodiment 1

(1) Total Structure of an Appurtenance Loan-Out System

FIG. 1 is a schematic diagram illustrating the structure of an appurtenance loan-out system of the Embodiment 1 of the present invention. Referring to FIG. 1, the appurtenance loan-out system comprises the storage equipment 10 that stores appurtenances to be loaned out to a resident, the control server 20 that controls the data relative to loan-out of the appurtenances, the user terminal 30 operated by the resident and the superintendent terminal 40 operated by a managerial entity personnel that manages and runs the appurtenance loan-out service; and wherein elements 10-40 are connected each other via the network 100.

(2) Structure of the Storage Equipment 10

The storage equipment 10, which is installed, e.g., in the common area of a housing complex, is an equipment having a storage and lockable function, e.g., a locker equipment.

FIG. 2 is a perspective view of a storage equipment 10 of the Embodiment 1 of the present invention.

FIG. 3 is a schematic diagram illustrating the structure of the storage equipment 10 of the Embodiment 1 of the present invention.

Hereafter, the inventor sets forth the structure of the storage equipment 10 of the present Embodiment.

Referring to FIG. 2, FIG. 3, the storage equipment 10 comprises a control element 11 having, e.g., CPU and so forth so as to control the total storage equipment 10; a storage element 12 having the storage boxes more than one so as to store appurtenances used for a variety of services provided in the housing complex; a data storage element 13 so as to store a variety of data; an operation element 14 having a variety of keys, to which the data can be input, and also having a reading function so as to read the data of, e.g., card-keys and so forth; a display element 15 so as to display a variety of the data; and a communication element 16 so as to execute sending and receiving the data via the network 100.

For example, the storage element 12 stores the key of the common area such as the conference room, the theater room and so forth or of the loan-out bicycle or a loan-out car as the above appurtenance. In addition, the storage element 12 stores, e.g., a wheeled, platform (truck. cart), an inflator, tool sets, e.g., screwdrivers sets, a tent, leisure goods, e.g., an inner tube and so forth, or gardening supplies, e.g., a shovel, a bucket and so forth.

As set forth above, the operation element 14 having a variety of keys and the resident can operate to input own resident ID or the password for authentication and to select the loan-out appurtenance when the resident loans out the appurtenance. Further, the operation element 14 can be integrally constructed with the display element 15 so as to be operative as a touch panel. The display element 15 displays whether each appurtenance is loanable or not at this time and display a message to remind an input of each data. Further, the resident can take the loan-out service of appurtenances and the loan-out booking service using the operation element 14 and the display element 15.

The communication element 16 sends the data (e.g., the resident ID for authentication, the password and so forth) inputs through the operation element 14 described above to the control server 20 via the network 100. Further, the communication element 16 receives the data relative to the status of authentication results described later and loan-out of appurtenances from the server 20.

(3) Structure of the Control Server 20

FIG. 4 is a schematic diagram illustrating the structure of a control server 20 of the Embodiment 1 of the present invention.

Referring to FIG. 4, the control server 20 comprises a control element 21 having, e.g., CPU and so forth so as to control the total control server 20; a data storage element 22 so as to store a variety of data; and a communication element 23 so as to send and receive the data via the network 100 to be connected.

The data storage element 22 controls and stores the variety of data relative to the appurtenance loan-out service, with which the appurtenance loan-out service provides the resident, in each database and so forth. The data storage element 22 stores the resident database 221 that control the resident data (hereafter resident DB 221), the appurtenance database 222 that controls the data of appurtenances to be loaned out to the resident (hereafter appurtenance DB 222), the loan-out history database 223 that controls the loan-out history of the appurtenance loaned out to the resident (hereafter loan-out history DB 223, the booking history database 224 (hereafter booking history DB 224), and the loan-out eligibility database 225 (hereafter loan-out eligibility DB 225) that controls how long the loanable length is and what is loanable appurtenance for each resident (loanable length.)

FIG. 5 is a table illustrating the structure of the resident DB 221 of the Embodiment 1 of the present invention. Referring to FIG., the resident DB 221 stores the personal data (e.g., address, e-mail address, phone number and so forth), the room number of the resident, and the authentication password are respectively referred to the individual ID (resident ID) that identify each resident.

FIG. 6 is a table illustrating the structure of an appurtenance DB 222 of the Embodiment 1 of the present invention. Referring to FIG., the appurtenance DB 222 stores the appurtenance item, the stored location of appurtenance (the storage equipment 10, the box number), the loan-out status and the booking status, which are corresponding to the individual ID (appurtenance ID) that identifies each appurtenance. A combination of, e.g., the premise ID where the storage equipment 10 is installed, the storage equipment 10 ID, and the box number, and so forth can be used to specify the stored location. Further, the loan-out status described above is blank when not loaned out, and the individual ID that identifies the loan-out status is written where loaned out. Further, the booking status described above is blank when not booked, and the individual ID that identifies the booking is written.

FIG. 7 is a table illustrating the structure of a loan-out history DB 223 of the Embodiment 1 of the present invention. Referring to FIG. 7, the loan-out history DB 223 stores the appurtenance ID of actually appurtenance loaned out, the time when loaned out, the scheduled return time, and the time when returned, which are corresponding to the loan-out ID described above. The scheduled return time is the time after the loanable length described above is passed off from the time when loaned out. For example, the time when loaned out is “August 1, 1300 hours”, and the loanable time for the loaner-resident is 3 hours, the scheduled return time must be “August 1, 1600 hours” when 3 hours after loaned out.

When the appurtenance is not returned yet, “the returned time” is blank and when returned, the time when actually returned is written by the control element 21.

FIG. 8 is a table illustrating the structure of a booking history DB 224 of the Embodiment 1 of the present invention. Referring to FIG., the booking history DB 224 stores the appurtenance ID of the booked loan-out appurtenance, the booked time when loaned out, and the booked scheduled return time; which are corresponding to the booking ID described above. The booked return time is the time after the loanable length described above is passed off from the time when loaned out. For example, when the booked loan-out time is “August 1, 1300 hours”, and the loanable time for the loaner-resident is 3 hours, the booked scheduled return time must be “August 1, 1600 hours”, 3 hours passed after loaned out. Further, the resident can set any time relative to the booked return time between the booked loan-out time and the time when the loanable time is passed off after the booked loan-out time.

FIG. 9 is a table illustrating the structure of a loan-out eligibility DB 225 of the Embodiment 1 of the present invention. Referring to FIG., the loan-out eligibility DB 225 stores the loanable length that specifies the longest loanable length of each appurtenance, which is corresponding to the resident ID described above. The loanable length can be different or common from a resident to a resident relative to the same or the same of the appurtenance item. Further, relative to the loan-out eligibility DB 225, the loanable length is registered as “null” so that the specific resident can be declined to make a loan-out of the designated appurtenance.

Further, relative to the loan-out eligibility DB 225, the loanable length can be manually one by one input to set and can be automatically set to register based on the data controlled in the resident DB 221. For example, relative to the resident DB 221, the loanable length can be automatically set to register in the loan-out eligibility DB 225 based on the age of each resident, the length of applying the appurtenance loan-out service, or the residing length of the resident in the housing complex and so forth. For example, it can be set that the loan-out per se or the loan-out length of the appurtenance relative to young resident or old resident can be limited and the resident residing in the housing complex for a long time can be given a privilege of a long loanable length.

(4) Structure of the User Terminal 30

The user terminal 30 is a data processing device operated by the resident in the housing complex and can be a portable communication terminal, e.g., a smartphone, a cell phone, a personal handy-phone system (PHS), or a personal data assistant (PDA) and so forth, or a personal computer (PC), e.g., a tower computer, a desktop computer, and a notebook computer. The user terminal 30 comprises an operation element including a key-switch and so forth and a display screen and is operable to input and display the data. Further, the user terminal 30 can send the data to and receive from the control sever 20 via the network 100.

The resident can access to the control server 20 to confirm the loan-out status and the loan-out booking status due to the storage equipment 10 and to book the loan-out by using the user terminal. Further, when the resident does not return the appurtenance to the storage equipment 10 by the scheduled time or never show up to make a loan-out and so forth, the control server 20 sends the data showing the incident to the user terminal 30 to the resident to remind the appurtenance return and so forth.

(5) Structure of the Controller Terminal 40

The controller terminal 40 is a data processing device operated by the controller managing and running the appurtenance loan-out service via the appurtenance loan-out system of the present Embodiment, and can be a portable communication terminal, e.g., a smartphone, a cell phone, a personal handy-phone system (PHS), or a personal data assistant (PDA) and so forth, or a personal computer (PC), e.g., a tower computer, a desktop computer, and a notebook computer. The controller terminal 40 comprises an operation element including a key-switch and so forth and a display screen and is operable to input and display the data. Further, the controller terminal 40 can send the data to and receive from the control sever 20 via the network 100.

The controller can access to the control server 20 through the controller terminal 40 to confirm the loan-out status and the loan-out booking status due to the storage equipment 10.

Operation due to the Embodiment 1

(1) The Loan-Out Operation of Appurtenances.

FIG. 10 is a decision tree illustrating the method of a loan-out operation sequence relative to an appurtenance loan-out system of the Embodiment 1 of the present invention. Next, referring to FIG. 10, the inventor sets forth the loan-out operation.

The resident, e.g., approximates the ID card to the reading means installed in the operation element 14 to read out the resident ID and the password written in the ID card (Step S101.) Then, the communication element 16 of the storage equipment 10 sends the read-out resident ID and the password to the control server 20 via the network 100 (Step S102.) The control element 21 of the control server 20 refers to the resident DB 221 and decides whether the received resident ID and the password from the storage equipment 10 are corresponding each other or not (Step S103.)

When stored correspondingly each other in the resident DB 221 (Step S103/Yes), the control element 21 of the control server 20 decides that the authentication is successful and identifies the loanable appurtenance at the present time by referring to the appurtenance DB 222, the loan-out history DB 223 and the booking history DB 224, and then sends the data that specifies the loanable appurtenance item to the storage equipment 10 (Step S104.) At this time, for example, the control element 21 decides whether the appurtenance is currently stored in the storage box or not, whether the loan-out booking relative to the specified appurtenance item between the present time and the end of loanable length is made or not, and so forth, and then identifies the loanable appurtenance at the present time. In addition, the control element 21 sends the data showing the authentication result of the success authentication to the storage equipment 10 (Step S105.)

On the other hand, when not corresponding each other (Step S103/No), the control element 21 sends the data showing the authentication result of the failure authentication to the storage equipment 10 (Step S105.)

The storage equipment 10 receives the data showing the authentication result from the control server 20 and if the content showed by the data is the failure authentication (Step S106/No), the loan-out of the appurtenance is not performed and the processing is over as is.

In contrast, in the case of the success authentication (Step S106/Yes), the display element 15 displays the list of loan-out appurtenances in the relevant storage equipment 10 (Step S107). At this time, the display element 15 displays differently the loanable appurtenance this time by changing the letter color or the background thereof from loaned out or booked appurtenances based on the data, specifying the loanable appurtenance item, received from the control server 20 described above. At this time, when the appurtenance that the resident requests to be loaned out is not loanable because of being loaned out or other reasons this time, the processing is over. On the other hand, when loanable, the resident selects the item of the appurtenance among the displayed loanable appurtenances by using the operation element 14 (Step S108.) At this time, the storage equipment 10 sends the data relative to the selected appurtenance item to the control server 20 (Step S109.)

The control element 21 of the control server 20 extracts the appurtenance ID of the appurtenance item referring to the appurtenance DB 222 when receiving the data relative to the appurtenance item from the storage equipment 10 (Step S110.) Next, the control element 21 issues a loan-out number and writes the appurtenance ID of the loan-out appurtenance, the loan-out time (present time), and the scheduled return time, and the resident ID received on authentication to the loan-out history DB 223 corresponding to the loan-out number (Step S111.) Next, the control element 21, referring to the appurtenance DB 222, extracts the box number of the storage box storing the appurtenance (Step S112) and the communication element 23 sends the unlocking signal of the storage box having the corresponding box number along with the data relative to the extracted box number (Step S113.)

The storage equipment 10 unlocks the storage box having the corresponding box number when receiving the data of the box number described above and the unlocking signal from the control server 20 (Step S114.) The resident opens the door of the unlocked storage box and takes out the appurtenance to use. Now, the loan-out operation of appurtenances is over.

(2) The Loan Booking Operation of the Appurtenance by Operating the Storage Equipment 10.

FIG. 11 is a decision tree illustrating the loan-out booking operation method relative to an appurtenance loan-out system of the Embodiment 1 of the present invention. Next, referring to FIG. 11, the inventor sets forth the corresponding booking operation method.

The resident visits the installed location of the storage equipment 10, operates the operation element 14, and makes a loan-out booking of the appurtenance. The resident, e.g., approximates the ID card to the read-out means installed in the operation element 14 to read out the resident ID and the password written in the ID card (Step S201.) Then, the communication element 16 of the storage equipment 10 sends the readout resident ID and the password to the control server 20 via the network 100 (Step S202.) The control dement 21 of the control server 20, referring to the resident DB 221, decides whether the received resident ID and the password from the storage equipment 10 are corresponding each other or not (Step S203.)

When not corresponding each other in the resident DB 221 (Step S203), the control element 21 sends the data showing the authentication result as the failure authentication to the storage equipment 10 (Step S204.)

The storage equipment 10 receives the data showing the authentication result from the control server 20 and if the content showed by the data is the failure authentication (Step S205/No), the loan-out booking of the appurtenance is not made and the processing is over as-is.

When correspondingly stored each other in the resident DB 221 (Step S203), the control element 21 of the control server 20 decides that the authentication is successful and then sends the data showing the authentication results to the storage equipment 10 (Step S204.) When the storage equipment 10 receives the data showing the authentication result from the control server 20 and the data content show the success authentication (Step S205/Yes), the display element 15 displays the list of loan-out booking appurtenances in the corresponding storage equipment 10 (Step S206.) The resident designates the appurtenance item from the list, which the resident wants to book loan-out, by operating the operation element 14 (Step S207.) The communication element 16 of the storage equipment 10 sends the data relative to the designated appurtenance item to the control server 20 (Step S208.)

The control element 21 of the control server 20 extracts the appurtenance ID of the appurtenance item referring to the appurtenance DB 222 when receiving the data relative to the appurtenance item from the storage equipment 10 (Step S209.) Next, the control element 21, referring to the loan-out history DB 223 and the booking history DB 224 based on the extracted appurtenance ID, detects the available booking time (Step S210) and sends the corresponding data to the storage equipment 10 (Step S211.) Relative to the step S210, the control element 21 detects the time not beyond the loanable length during the loanable length. For example, the control element 21 decides that the loanable length 3 hours at longest (e.g., 1400 hours-1700 hours, 1800 hours-1900 hours), i.e., the loan-out begins between 1200 hours and1800 hours and the loan-out ends at 1900 hours at latest when the loanable length of the corresponding appurtenance is 3 hours and the available booking is between 1200 hours and 1900 hours, and so forth.

When receiving the data showing the available booking time from the control server 20, the storage equipment 10 displays the data on the display 15 (Step S212.) The resident designates the preferable time from the displayed loanable length through the operation element 14 (Step S213.) The communication element 16 sends the data showing the designated length to the control server 20 (Step S214.)

The control server 20 issues a loan-out number and writes the appurtenance ID of the selected appurtenance item described above and the designated booking time to the booking history DB 224, corresponding to the resident ID received on authentication, when the data showing the designated length, the resident ID and the data showing the appurtenance item from the storage equipment 10 are received (Step S215.) Now, the loan-out booking operation of appurtenances is over.

(3) The Loan-Out Operation of Appurtenances Booked for Loan-Out.

FIG. 12 is a method decision tree illustrating the procedural loan-out sequence of the booked appurtenance to be loaned out relative to an appurtenance loan-out system and method ****of the Embodiment 1 of the present invention. Hereafter, referring to FIG., the inventor sets forth the loan-out operation.

The resident visits the installed location of the storage equipment 10 during designated booking hours and receives the loan-out booked appurtenance following the loan-out booking as described above. At this time, the resident is subject to authentication using the ID card as well as at the booking and requests for loan-out of the booked appurtenance (Step S301-S303.)

The control element of the control server 20 decides, in the case of the success authentication (Step S303/Yes), referring to the booking history DB 224, whether the present time is within the booking length or not (Step S304), and if Yes (Step S304/Yes), writes the loan-out data to the appurtenance DB 222 and the loan-out history DB 223 (Step S305.) Specifically, now, the control element 21 writes each term in the field of “loan-out status” in the appurtenance DB 222 and the field of “loan-out time” and “scheduled return time” in the loan-out history DB 223.

Next, the control element 21, referring to the appurtenance DB 222, extracts the box number of the storage box storing the appurtenance (Step S306) and the communication element 23 sends the unlocking signal of the storage box having the corresponding box number along with the data relative to the storage equipment 10 (Step S307.)

The storage equipment 10 unlocks the storage box having the corresponding box number when receiving the data of the box number described above and the unlocking signal from the control server 20 (Step S308.) The resident opens the door of the unlocked storage box and takes out the appurtenance to use. Now, the loan-out operation of the booked appurtenances is over.

(4) The loan-out booking operation of appurtenances using the user terminal 30 As set forth above, the resident can make a loan-out booking of the appurtenance not only by direct operation of the storage element 10, but also can make such operation through own user terminal. FIG. 13 is a decision tree illustrating the procedural loan-out booking sequence of the appurtenance using a user terminal 30 relative to an appurtenance loan-out system of the Embodiment 1 of the present invention. Next, referring to FIG., the inventor sets forth the loan-out operation using the user terminal 30.

The resident inputs the resident ID and the password by operating the user terminal 30 (Step S401.)

At this time, for example, the resident can access the appurtenance loan-out page of the website and input the resident ID and so forth into the input field of the page or input on the application (software) installed on the user terminal 30.

Next, the user terminal 30 sends the input resident ID, the password thereof to the control server 20 via the network 100 (Step S402.)

The control element 21 of the control server 20 refers to the resident DB 221 and decides whether the received resident ID and the password from the user terminal 30 are corresponding each other or not. (Step S403.)

When not corresponding each other in the resident DB 221 (Step S403), the control element 21 sends the data showing the authentication result of the failure authentication to the user terminal 30 (Step S404.)

The user terminal 30 receives the data showing the authentication result from the control server 20 and if the content showed by the data is the failure authentication (Step S405/No), the loan-out booking of the appurtenance is not made and the processing is over as-is.

When stored correspondingly each other in the resident DB 221 (Step S403), the control element 21 of the control server 20 decides that the authentication is successful and then sends the data showing the authentication result thereof to the user terminal 30 (Step S404.)

When the user terminal 30 receives the data showing the authentication result from the control server 20 and the data content shows the success authentication (Step S405/Yes), the list of loan-out booking appurtenances in the user terminal 30 is displayed on the screen (Step S406.) The resident designates the appurtenance item from the list, which the resident wants to book a loan-out, by operating the user terminal 30 (Step S407.) The user terminal 30 of sends the data showing the designated appurtenance item to the control server 20 (Step S408.)

The control element 21 of the control server 20 extracts the appurtenance ID of the appurtenance item referring to the appurtenance DB 222 when receiving the data relative to the appurtenance item from the user terminal 30 (Step S409,) Next, the control element 21, referring to the loan-out history DB 223 and the booking history DB 224 , detects the available booking time based on the extracted appurtenance ID (Step S410) and sends the corresponding data to the user terminal 30 (Step S411.) Further, the available booking time here is the duration of no existing loan-out or no existing loan-out booking.

When receiving the data showing the available booking time from the control server 20, the user terminal 30 displays the data on the display (Step S412.) At this time, the resident reviews the displayed available booking time so that the resident can easily make sure the loan-out status and the loan-out booking status of the appurtenance. The resident designates the preferable time during the displayed loanable length from the user terminal 30 (Step S413). The user terminal 30 sends the data relative to the designated length to the control server 20 (Step S414.)

The control server 20 issues a loan-out number and writes the appurtenance ID of the selected appurtenance item described above and the designated booking time to the booking history DB 224, corresponding to the resident ID received on authentication when the data showing the designated length, the resident ID and the data showing the appurtenance item from the user terminal 30 are received (Step S415.) Now, the loan-out booking operation of appurtenances using the user terminal 30 is over.

In addition, as set forth above, the resident can make sure the loan-out status and the loan-out booking status of the appurtenance using the user terminal 30 when loan-out is booked, but also the resident can make sure just the loan-out status and the loan-out booking status without making actual loan-out booking. The inventor shall not describe the processing thereof because of the same as Step S201-S206.

(5) The Notice Operation of the Control Server 20.

As set forth above, the individual loanable length of each appurtenance is set for each resident and each appurtenance in the appurtenance DB 222 (FIG. 6.) The resident can make a loan-out of the appurtenance only between the beginning of loan-out and the end of the corresponding loanable length, If the resident does not return after the end of the corresponding length, or if the resident does not make a loan-out of the appurtenance at the booked loan-out time and even beyond the scheduled length, the control server 20 sends the notice to the user terminal 30 to remind the return thereof or make a loan-out thereof.

First, when the resident does not return the appurtenance, as set forth below, the control element 21 of the control server 20 decides, referring to the loan-out history DB 223 every predetermined time, whether the present time is beyond “the scheduled return time” in the loan-out history DB 223 or not or the actual return time is written in the field of “return time” or not. The control element 21 sends the notice mail, e.g., the mail address, to remind the return referring to the resident DB 221 when it is decided that no return takes place because the present time passes the “scheduled return time” in the loan-out history DB 223 and the actual return time is not written in the field of “return time”.

Next, when the resident also does not show up to receive the appurtenance, as set forth below, the control element 21 of the control server 20 decides, referring to the loan-out history DB 224 every predetermined time, whether the present time is beyond “the scheduled loan-out time” and “the scheduled return time” in the loan-out history DB 224 or not. The control element 21 sends the notice mail, e.g., the “mail address”, to remind the loan-out referring to the resident DB 221 when it is decided that the present time passes the “scheduled loan-out time” in the booking history DB 224 but does not pass the “scheduled return time” and the appurtenance is not loaned out from the storage equipment 10 within the booked loan-out time. In addition, the control element 21 rejects loan-out of the appurtenance per se because the accepted loanable length of the appurtenance per se passes when both the “booked loan-out time” and the “scheduled return time” pass.

According to the Embodiment set forth above, the notice is sent to the user terminal 30 via email, but any other method can be applied. For example, the control server 20 may send the notice to the user terminal 30 and may send the notice to remind the turn on the web page displayed on the user terminal or in the application installed in the user terminal 30.

Summary of the Embodiment 1 and the related methods of use and operation of the same.

As set forth above, according to the Embodiment of the present invention, the storage equipment 10 can structure-wise store appurtenances and make a loan-out of an appurtenance to the resident having the success authentication for the predetermined length so that the managerial works in the housing complex can be reduced and a variety of appurtenances corresponding to the diversification of needs of the resident can be loaned out.

In addition, the control server 20 controls the loan-out status and the loan-out booking status of appurtenances in the databases so that the resident can make sure easily the present loan-out status and the present loan-out booking status of appurtenances through the user terminal 30.

In addition, control server 20 controls the longest loanable length of each appurtenance or whether loan-out per se is allowed or inhibited every resident in the loan-out eligibility database 225 so that fine appurtenance loan-out services, e.g., the resident who is younger than the appropriate age for use of the appurtenance cannot make a loan-out per se or can make a loan-out for a limited length and so forth, can be provided.

In addition, the appurtenance loan-out system of the Embodiment of the present invention can process the loan-out booking of appurtenances but also can constitute without such processing. Specifically, the storage equipment 10 can only display as not-loanable if loaned out at the present time and can make a loan-out by unlocking to loan out if stored in the storage element 12 at the present time following the success authentication.

### Embodiment 2

### Structure of the Embodiment 2

According to the Embodiment 1 described above, the control server 20 controls each database and a variety of data relative to authentication and appurtenance loan-out, but the storage equipment 10 can comprise all structures or a part of the control server 20. For example, the storage equipment 10 can control the resident DB 221 and execute an authentication processing. Further, the storage equipment 10 can control the appurtenance DB 222, and execute the processing relative to the loan-out history and the loan-out booking. The appurtenance loan-out system can have the control server or have not structurally as well as the Embodiment described above when the storage equipment 10 comprise all structure and functions of the control server 20. Hereafter, unless otherwise specifically designated, the inventor sets forth as the structures and the operations of the present Embodiment are the same as the Embodiment 1.

(1) Total Structure of an Appurtenance Loan-Out System

FIG. 14 is a schematic diagram illustrating the structure of an appurtenance loan-out system of the Embodiment 2 of the present invention. Referring to FIG., the appurtenance loan-out system of the present Embodiment comprises the storage equipment 10, the user terminal 30 and the controller terminal 40, but not the control server 20. According to the aspect of the Embodiment 1, the control server 20 controls each database 221-225, an authentication, a loan-out of appurtenance, and a booking an so forth, but according to the aspect of the present Embodiment, instead of control by the control server 20, the storage equipment 10 controls each database 221-225 described above and the authentication and so forth.

(2) Structure of the Storage Equipment 10.

FIG. 15 is a schematic diagram illustrating the structure of the storage equipment 10 of the Embodiment 2 of the present invention. Referring to FIG., the storage equipment 10, as well as the Embodiment 1, comprises a control element 11, a storage element 12, a data storage element 13, an operation element 14, a display element 15 and a communication element 16. Further, referring to FIG., the data storage element 13 stores and controls the resident DB 221, the appurtenance DB 222, the loan-out history DB 223, the booking history DB 224 and the loan-out eligibility DB 225. Each database 221-225 is in order to control the same data as in each database 221-225 that the control server 20 in the aspect of the Embodiment 1 controls.

### Operation of the Aspect to the Embodiment 2

According to the aspect of the present Embodiment, the storage equipment 10 executes the authentication processing referring to the resident DB 221 stored in the data storage element 13 when the resident ID and the password are input, and if the success authentication, executes the loan-out processing or the booking processing continuously. The storage equipment 10 executes to control loan-out and booking for the control server 20.

### Summary of the Embodiment 2

As set forth above, according the aspect of the present Embodiment, the same effect as that in the aspect and methods of the Embodiment 1 can be provided and the storage equipment 10 alone executes each processing relative to an authentication, a loan-out and a loan-out booking of the control server 20 so that the appurtenance loan-out system can be brought into reality with the simple structure.

In addition, according to the aspect of the Embodiment 1, the storage equipment 10 is connected to the user terminal 30 and the controller terminal 40 via the network 100, but the structure thereof can be off-line (standalone) without connecting to the network 100. In the case of such structure, the storage equipment 10, as set forth above, independently executes each processing relative to authentication, loan-out and loan-out booking, but makes no notice to the user terminal 30 to remind the return of the appurtenance and loan-out.

### Embodiment 3

### Structure of the Embodiment 3

In the appurtenance loan-out system according to the Embodiment 3 of the present invention, the storage equipment 10 is connected to the control server 20 via the network 100 as well as in the aspect of the Embodiment 1 but it is different therefrom that the storage equipment 10 executes a part of each processing relative to an authentication, a loan-out and a loan-out booking for the control server 20. Hereafter, unless otherwise specifically designated, the inventor sets forth as the structures and the operations of the present Embodiment are the same as the Embodiment 1.

According to the present Embodiment, the storage equipment 10 stores parts of data of the data controlled in each database 221-225 relative to the aspect of the Embodiment 1 into the data storage element 13 to constitute a database.

### Operation of the Aspect to the Embodiment 3

According to the aspect of the present Embodiment, the storage equipment 10 executes the processing executed by the control server 20 according to the Embodiment 1 by using the data in the own controlled database described above so that the processing burden due to the control server 20 can be reduced. For example, the storage equipment 10 controls the resident DB 221 in the data storage element 13 for the control server 20 so that the authentication processing can be executed for the control server 20 when the resident ID and the password and so forth are input through the operation element 14. In this case, the storage equipment 10 can execute the authentication processing without sending to and receiving the data from the control server 20 so that the traffic volume in the network 100 can be reduced.

### Summary of the Embodiment 3

As set forth above, according the aspect of the present Embodiment, the same effect as that in the aspect of the Embodiment 1 can be provided and the storage equipment 10 alone executes each processing relative to an authentication, a loan-out and a loan-out booking of the control server 20 so that a variety of processing loads on the control server 20 can be reduced, and also the sending and receiving volume of the data via the network 100 can be reduced, and the traffic efficiency of the network 100 can be brought into reality with the simple structure.

### Embodiment 4

### Aspect of the Embodiment 4

The appurtenance loan-out system, according to the Embodiment 4 of the present invention, comprises the storage equipment 10, the control server 20, the user terminal 30, the controller terminal 40 and the network 100 connecting 10-40 as well as in the aspect of the Embodiment 1. According to the aspect of the Embodiment 1, only the control server 20 stores and controls all databases 221-225, and executes each processing relative to an authentication, a loan-out of appurtenance, and a booking and so forth. In contrast, the aspect of the present Embodiment, both storage equipment 10 and the control server 20 comprises databases 221-225 respectively and the storage equipment 10 executes each processing. Then, the storage equipment 10 and the control server 20 share the data in each other's owning databases 221-225. Hereafter, unless otherwise specifically specified, the inventor sets forth as the structures and the operations of the present Embodiment are the same as the Embodiment 1.

### Structure of the Embodiment 4

(1) Structure of the Storage Equipment 10

The storage equipment 10 stores and controls each database 221-225 in the data storage element 13. The storage equipment 10 refers to each kind of data in each database 221-225 or writes each kind of data into each database 221-225 when processing an authentication, a loan-out and a loan-out booking. The inventor does not set forth the detail of processing because the detail thereof is the same as that in the Embodiment 1.

(2) Structure of the Control Server 20

The control server 20 as well as the storage equipment 10 stores and controls each database 221-225 in the data storage element 22. The detail data that each database 221-225 of the control server 20 controls synchronize with each database 221-225 in the storage equipment 10 described above and are common. When the user terminal 30 and the controller terminal 40 request for acquisition of a variety of data for the control server 20 via the network 100, the control server 20 extracts the corresponding data from each database 221-225 and sends the extracted data to the requester terminal 30, 40 for the corresponding data. The user terminal 30 and the controller terminal 40 display the data on the screen thereof when receive a variety of data from the control server 20. For example, when the resident sends the request of acquisition of the data relative to the loan-out status of the appurtenance to the control server 20 using the user terminal 30, the control server 20, sharing the data with the storage equipment 10, extracts and sends the data relative to the loan-out status, referring to the appurtenance DB 222, the loan-out history DB 223 and the booking history DB 224 in the data storage element 22 to the user terminal 30.

### Operation of the Aspect to the Embodiment 4

(1) Synchronizing operation of the databases

The storage equipment 10 writes and updates the data in each database 221-225 when executes the loan-out processing and the loan-out booking processing. For example, when the appurtenance is loaned out or is booked, the storage equipment 10 writes the incident thereof in the appurtenance DB 222, the loan-out history DB 223, the booking history DB 224 and so forth. In addition, the storage equipment 10 rewrites and updates the data in the appurtenance DB 222, the loan-out history DB 223 and so forth when the loan-out appurtenance is returned. The storage equipment 10 stores the history thereof in the data storage element 13 every writing and updating in each database 221-225.

The control server 20 sends the signal to the storage equipment 10 in order to confirm every preset time whether writing or updating in each database 221-225 by the storage equipment 10 takes place or not. The storage equipment 10 sends the written and updated data to the control server 20 since the last confirmation signal was received, referring to the writing and updating history in each database 221-225 of the data storage element 13 when received the confirmation signal from the control server 20.

The control server 20 updates the field corresponding received data in each database 221-225 of the data storage element 22 when receives the written and updated data from the storage equipment 10. Then, synchronizing operation of the databases is over.

As set forth above, according to the present Embodiment, the control server 20 synchronizes the database with the storage equipment 10 every preset time so that the storage equipment 10 and the control server 20 can share the data. In addition, according to the aspect of the present Embodiment, the storage equipment 10 sends only the written and updated data to the control server 20, but the data including no written/updated data can be sent to synchronize the data.

(2) Confirmation Operation of the Loan-Out Status and the Booking Status.

According to the Embodiment 1, the resident make sure the loan-out status and the booking status by access to the control server 20 by operating the user terminal 30 (Step S401-.) As set forth above, according to the present Embodiment, the control server 20 synchronizes the data with the storage equipment 10 and then stores the data of each processing in the storage equipment 10. Accordingly, even according to the present Embodiment, as well as the Embodiment 1, the resident can make sure the loan-out status and the booking status by access to the control server 20 by operating the user terminal 30.

### Summary of the Embodiment 4

As set forth above, according to the present Embodiment, the storage equipment 10 shares a variety of data controlled in each database 221-225 with the control server 20 so that the proving processing relative to, e.g., the loan-out status of appurtenances can be distributed to the control server 20 and the processing load to the storage equipment 10 can be effectively reduced corresponding to the distributed load thereto, accordingly. In addition, even when the operation of the storage equipment 10 is suspended because of, e.g., maintenance, the resident can make sure of the loan-out status of the appurtenance from the control server 20 through the user terminal 30.

### Embodiment 5

### Aspect of the Embodiment 5

As set forth above, according to the aspect of the Embodiment 1-4, appurtenances are stored in the storage box of the storage equipment 10, which is used only for the loan-out of appurtenances. According to the aspect of the Embodiment 5 of the present invention, a part of the storage box of the storage equipment 10 is structured so as to be applied for a use other than a loan-out. Hereafter, unless otherwise particularly specified, the inventor sets forth as the structures and the operations of the present Embodiment are the same as the aspect of the Embodiment 1.

### Structure of the Aspect of the Embodiment 5

(1) Structure of the Storage Equipment 10

The storage element 12 of the present Embodiment comprises a plurality of storage boxes. A part of the plurality of storage boxes is used for storage of appurtenances as well as the Embodiment set forth above. The rest thereof is used for applications other than the storage of appurtenances but, according to the aspect of the present Embodiment. e.g., another application is a locker for a door-to-door delivery. The service to apply the storage equipment 10 to the door-to-door delivery is specified as a door-to-door locker service hereafter. With regard to the door-to-door locker service, the door-to-door delivery package attention to the resident or the superintendent is once stored in the storage box of the storage equipment 10 so that the package can be received even when, e.g., the resident is staying out without requesting the delivery man to redeliver. In addition, with regard to the door-to-door service, the resident or the superintendent stores once the package to be delivered in the storage box and then after the door-to-door delivery man can take out the package from the storage box so as to deliver.

The storage equipment 10 stores the box DB 226 that specifies the application of each storage box in the storage element 13. FIG. 16 is a table illustrating the structure of the data of an box DB 226 of the aspect of the Embodiment 5 of the present invention.

According to the example referring to FIG., either “1. storage of appurtenances” or “2. door-to-door delivery locker” as the application of each storage box in the box DB 226 is specified. Only the storage box specified as “1. storage of appurtenances” is applied for an appurtenance loan-out set forth in the aspects of the Embodiment 1-4 described above. On the other hand, the storage box specified as “2. door-to-door delivery locker” is applied for the door-to-door delivery locker service and excluded from an object of any processing following such as a loan-out of appurtenances when the loan-out authentication processing of the appurtenance is executed, as set forth in the aspect of the Embodiment 1. In contrast, when, for example, the data requesting for use of the door-to-door delivery locker is input through the operation element 14, the storage box specified as “2. door-to-door delivery locker” is the object of the following processing, and each processing or work including open-and-close the door, unlocking, and put in-and-out of the door-to-door package and the storage box specified as “1. storage of appurtenances” is excluded from the object of the following processing.

### Summary of the Embodiment 5

As set forth above, according to the Embodiment 5 of the present invention, the storage equipment 10 controls the database (box DB 226) specifying respectively the application of the plurality of storage boxes constituting the storage element 12 so that one storage equipment 10 can provide a plurality of different services using the storage equipment 10 and an effectiveness relative to the installation cost and space of the storage equipment 10 can be achieved accordingly.

### Summary of Embodiments

As set forth above, according to the aspects of Embodiments, the storage equipment 10 can structure-wise store appurtenances and make a loan-out of an appurtenance to the resident having the success authentication for the predetermined length so that the managerial works in the housing complex can be reduced and a variety of appurtenances corresponding to the diversification of needs of the resident can be loaned out.

The storage equipment 10, the control server 20, the user terminal 30 and the controller terminal 40 described above are brought into reality principally by CPU and programs loaded in the memory. However, a combination of any hardware and software other than that can make the equipment and the server and high freedom of such design can be easily understood by a person skilled in the art. In addition, when the storage equipment 10, the control server 20, the user terminal 30 and the controller terminal 40 set forth above constitute a group of software modules; the programs stored in an optical recording medium, a magnetic recording medium, a magneto-optical medium, or semiconductors and so forth can be loaded from the above medium or can be loaded from an connected outside device via the preset network.

In addition, the above aspects of Embodiments are examples of preferable Embodiments and the aspects of the Embodiment 1-3 are not limited to the examples and a variety of alternative examples can be applied unless departing from the scope of the present invention. For example, according to the aspects of the present Embodiments as set forth above, the resident let the reading means, which is installed in the operation element 14, read the resident ID and the password written in the ID card when authenticated, but at least each one thereof can be input using the key installed in the operation element 14. In addition, the resident may input the own room number instead of the resident ID.

According to the aspects of Embodiments described above, relative to the loan-out eligibility DB 225, it is set so as to decide whether each resident is eligible for loan-out every appurtenance item or not, but it can be set so as to decide every each appurtenance (appurtenance ID) or every storage box unit (“storage location” in appurtenance DB 222) of the storage equipment 10. In addition, according to the aspects of Embodiments described above, relative to the loan-out eligibility DB 225, the longest loanable length of each appurtenance for each resident is set, but the loanable duration instead of the longest loanable length can be set. In addition, according to the aspects of Embodiments, the person who uses an appurtenance is, e.g., a resident but not limited to the resident. For example, the superintendent in the housing complex also can make a loan-out or a loan-out booking by operating the user terminal 30. In such case, the loan-out eligibility DB 225 can set as the superintendent can loan out all appurtenances and always without length limitation as an incentive.

### REFERENCE OF SIGNS

10 Storage equipment

11, 21 Control element

12 Storage element

13, 22 Data storage element

14 Operation element

15 Display element

16, 23 Communication element

20 Control server

30 User terminal

40 Controller terminal

100 Network

221 Resident DB

222 Appurtenance DB

223 Loan-out history DB

224 Booking history DB

225 Loan-out eligibility DB

226 Box Data Base

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A storage equipment system, installed in a housing complex, comprises:
a plurality of lockable storage boxes each operable to store appurtenances;
said lockable storage box operable to unlock when an external resident provides an authentication based upon a predefined resident ID that distinguish each said resident from a plurality of said external residents; and
wherein:
at least one appurtenance selected from a group of appurtenances consisting of: keys of common areas in said housing complex; vehicle keys, wheeled platforms, tools, leisure/picnic goods, and gardening supplies as said appurtenances.

2. The storage equipment system, according to claim 1, wherein:
said storage equipment system further controlling:
a database operable to allow a management application to target only said storage box from among said plurality of said storage boxes; and
an authentication process operable to execute a loan-out of said appurtenances upon an authentication for one of said external residents by referring to a database set up to store appurtenances, and operable to unlocked said lockable storage box upon said authentication.

3. An appurtenance loan-out system, comprises:
a plurality of lockable storage boxes each operable to store appurtenances;
said lockable storage box operable to unlock when an external resident provides an authentication based upon a predefined resident ID that distinguish each said resident from a plurality of said external residents; and
wherein:
at least one appurtenance selected from a group of appurtenances consisting of: keys of common areas in said housing complex; vehicle keys, wheeled platforms, tools, leisure/picnic goods, and gardening supplies as said appurtenances;
said appurtenance loan-out system further controlling:
a database operable to allow a management application to target only said storage box from among said plurality of said storage boxes; and
an authentication process operable to execute a loan-out of said appurtenances upon an authentication for one of said external residents by referring to a database set up to store appurtenances, and operable to unlocked said lockable storage box upon said authentication;
a control server that controls said storage equipment and an loan-out of the appurtenance connected thereto via a network, and
a user terminal connected to said control server via the network;
wherein said storage equipment sends the input data to said control server when said resident inputs the data specifying a preferable appurtenance item, said control server refers to the database when the data specifying said appurtenance item is received from said storage equipment, specifies said storage box storing the appurtenance item, and sends the signal to unlock the identified storage box to said storage equipment so that the storage box can be unlocked.

4. The appurtenance loan-out system, according to claim 3, wherein:
said control server controls the allowable loan-out length specifying the longest allowable loan-out length of the appurtenance every appurtenance relative to each resident, and sends a reminder to remind the appurtenance to said user terminal of the resident making the loan-out of said appurtenance when the allowable loan-out length from the time of loan-out of said appurtenance is over.

5. The appurtenance loan-out system according to claim 4, wherein:
said storage equipment sends the input data to said control server when the data specifying the appurtenance item of the loan-out booking and the data relative to the time of the loan-out booking are input;
said control server refers to the database when the data specifying said appurtenance item subject to the loan-out booking and the data relative to the time of the loan-out booking are received; registers the loan-out booking of the appurtenance based on the received data when no other booking is registered; and
sends the signal to unlock the storage box of the appurtenance to said storage equipment when the request for the loan-out of the appurtenance based on the registered booking is received from said storage equipment so that the storage box can be unlocked.

6. The appurtenance loan-out system, according to claim 5, wherein:
said user terminal sends the input data to said control server when the data specifying the appurtenance item subject to the loan-out booking and the data relative to the time of the loan-out booking are input;
said control server refers to the database when the data specifying said appurtenance item subject to the loan-out booking and the data relative to the time of the loan-out booking are received; registers the loan-out booking of the appurtenance based on the received data when no other booking is registered; and
sends the signal to unlock the storage box for the appurtenance to said storage equipment when the loan-out request for the appurtenance based on the registered booking is received from said storage equipment, so that the storage box can be unlocked.

7. The appurtenance loan-out system, according to claim 6, wherein:
said control server sends the data to said user terminal of said resident, who has booked, to remind executing the loan-out of the appurtenance when said booked and registered appurtenance is still not yet loaned out even by said booked time.

8. The appurtenance loan-out system, according to claim 8, wherein:
said storage equipment comprises the same database structure as the database structure that said control server has and the data in said database thereof can be shared with said control server.

9. An appurtenance loan-out system, comprising:
a plurality of lockable storage boxes each operable to store appurtenances;
said lockable storage box operable to unlock when an external resident provides an authentication based upon a predefined resident ID that distinguish each said resident from a plurality of said external residents: and
wherein:
at least one appurtenance selected from a group of appurtenances consisting of keys of common areas in said housing complex; vehicle keys, wheeled platforms, tools, leisure/picnic goods, and gardening supplies as said appurtenances;
said storage equipment system further controlling:
a database operable to allow a management application to target only said storage box from among said plurality of said storage boxes; and
an authentication process operable to execute a loan-out of said appurtenances upon an authentication for one of said external residents by referring to a database set up to store appurtenances, and operable to unlocked said lockable storage box upon said authentication;
a control server that controls said storage equipment and an loan-out of the appurtenance connected thereto via a network, and
a user terminal connected to said control server via the network:
wherein said storage equipment sends the input data to said control server when said resident inputs the data specifying a preferable appurtenance item, said control server refers to the database when the data specifying said appurtenance item is received from said storage equipment, specifies said storage box storing the appurtenance item, and sends the signal to unlock the identified storage box to said storage equipment so that the storage box can be unlocked;
a user terminal, which is operatable by said resident during a use and is operably connected to said storage equipment via the network; and
wherein said storage equipment refers to the database when said resident inputs the data specifying a preferable appurtenance item; specifies said storage box storing the appurtenance item, and unlocks the identified storage box.

10. The appurtenance loan-out system, according to claim 9, wherein:
wherein said storage equipment controls the allowable loan-out length specifying the longest allowable loan-out length of the appurtenance every appurtenance relative to each resident, and sends the data so as to remind the return of the appurtenance to said user terminal of the resident making the loan-out of said appurtenance when the allowable loan-out length from the time of loan-out of said appurtenance is over.

11. The appurtenance loan-out system, according to claim 10, wherein:
said storage equipment refers to the database when the data specifying the appurtenance item subject to the loan-out booking and the data relative to the time of the loan-out booking are input; registers the loan-out booking of the appurtenance based on the received data when no other booking is registered; and unlocks the storage box of the appurtenance when the request for loan-out of the appurtenance based on the registered booking is input.

12. The appurtenance loan-out system, according to claim 11, wherein:
said user terminal sends the input data to said control server when the data specifying the appurtenance item of the loan-out booking and the data relative to the time of the loan-out booking are input; said storage equipment refers to the database when the data specifying the appurtenance item subject to the loan-out booking and the data relative to the time of the loan-out booking are received; and registers the booking of the appurtenance loan-out based on the received data when no other booking is registered, and unlocks the storage box of the appurtenance when the request for loan-out of the appurtenance is input based on the registered booking.

13. The appurtenance loan-out system, according to claim 12, wherein:
said storage equipment sends the data to said user terminal of said resident, who has booked, to remind executing the loan-out of the appurtenance when said booked and registered appurtenance is still not yet loaned out even by said booked time.

14. A method of operating an appurtenance loan-out system, comprising the steps of:
providing a plurality of lockable storage boxes each operable to store external appurtenances; said lockable storage boxes operable to selectively unlock when an external resident provides an authentication based upon a predefined resident ID that distinguish each said resident from a plurality of said external residents;
providing a database operable to allow a management application to target and select only one said storage box from among said plurality of said storage boxes;
providing an authentication process operable to execute a loan-out of said appurtenances upon an authentication for one of said external residents by referring to a database set up to store appurtenances and operable to unlocked said lockable storage box upon said authentication.
providing an operable database functional to allow a management application to target only said storage box from among said plurality of said storage boxes; said operable database including an authentication process operable to execute a loan-out of said appurtenances upon an authentication for one of said external residents by referring to said database additionally capable of storing indicia representative of said appurtenances and operable to unlocked said lockable storage box upon said authentication;
providing a control server that controls said storage equipment and a loan out of the appurtenance connected thereto via an inter-operative network including said database, said management application, and said plurality of storage boxes;
providing a user terminal connected to said control server via the network for an input of a user control and said predefined resident ID as well as a user ID card containing a password written in said ID card; and
further comprising the steps of:
inputting said resident ID into said user terminal including a reading of password from said ID card;
transmitting a read-out of said resident ID and said password via said network to said authentication process;
said authentication process linking with said operable database function and said management application to determine whether or not a received resident ID and said password correspond to each other; and
(a) upon a determination of correspondence between said resident ID and said password, said authentication process identifies at said user terminal a loanable appurtenance by referring to both a loan-out history and a booking history and sends data including an indicia of specific loanable appurtenances for said system and determines further whether or not a loan-out booking relative to the specified appurtenance items between a present time and an end of a pre-determined loanable time period can be met; and
transmits an identification of a lownable appurtenance at a present time to said user; and
(b) upon a determination of non-correspondence between said resident ID and said password transmitting a notification of a non-correspondence to said user at said user terminal and an indicia of failure to authenticate said resident ID and said password.

15. The method, according to claim 14, further comprising the steps of:
upon said determination of correspondence driving a display element to display a list of selected ones of said stored external appurtenances in designated ones of said plurality of lockable storage boxes;
said authentication process and said control server updating a displayed indicia for said loaned-out appurtenance confirming a status of said appurtenance and additionally sending data relative to a selected appurtenance to said database and said control server.
